(19) United States
(12) Patent Application Publication
(10) Pub. No.: US 2019/0054631 A1
(43) Pub. Date: Feb. 21, 2019

(54) SYSTEM AND METHOD FOR OPERATING AND CONTROLLING A HYPER CONFIGURABLE HUMANOID ROBOT TO PERFORM MULTIPLE APPLICATIONS IN VARIOUS WORK ENVIRONMENTS

(71) Applicant: NIRANJAN CHANDRIKA GOVINDARAJAN, Coimbatore (IN)

(72) Inventor: NIRANJAN CHANDRIKA GOVINDARAJAN, Coimbatore (IN)

(21) Appl. No.: 15/770,502

(22) PCT Filed: Dec. 26, 2016
(86) PCT No.: PCT/IN2016/050458

§ 371 Date: Apr. 24, 2018

(30) Foreign Application Priority Data
Dec. 28, 2015 (IN) 7012/CHE/2015

(51) Int. Cl. B25J 13/08; B25J 9/16; G05B 19/4155

(52) U.S. Cl. CPC B25J 13/08; B25J 9/1664; G05B 2219/40302; G05B 2219/24162; G05B 19/4155

(57) ABSTRACT

A processor implemented method for performing and controlling a humanoid robot is provided. The method includes the following steps: (i) obtaining a data from a perception unit to analyze a work environmental conditions, (ii) providing communication between (a) the humanoid robot and a cloud server, and (b) the cloud server and one or more robots, (iii) detecting an acquisition of image and distance information about the working environmental condition or one or more applications to create a map of the working environmental condition for navigation, (iv) providing a feedback and control information to the humanoid robot, and (v) providing an input to the humanoid robot based on the one or more sensors or the user devices or the user to perform a necessary action for the working environmental condition or the one or more applications.

### CROSS-REFERENCE TO PRIOR FILED PATENT APPLICATIONS

This application claims priority from PCT Patent Application number PCT/IN2016/050458 filed on Dec. 26, 2016 the complete disclosure of which, in its entirely, is herein incorporated by reference

### BACKGROUND

### Technical Field

The embodiments herein generally relate to a hyper configurable humanoid robot, and, more particularly, to a system and method for operating and controlling of hyper configurable humanoid robot to perform multiple applications in various work environments.

### Description of the Related Art

Robots are automated robotic device implementation. It can accept the human commands, and you can run pre-programmed procedures, it may be based on the principles of artificial intelligence technology developed by the Program of Action. Its mission is to assist or replace human work tasks such as production, construction, or dangerous work.

In recent years, humanoid robots have become a massive research field of robotics. The humanoid robot compared to other types of robots has incomparable advantages, ease of integration into our daily life and work environment to help humanity accomplish specific tasks. Thus requirement of a single platform which can be customized for wide variety of applications is of prime importance. However humanoid robot as a complex system device needs for an effective use of their multi-sensor information to sense changes in the external environment and their own state, and make adjustments to the movement of the actuator, thus requiring their control system to be highly reliable and real-time. The Design must be highly flexible in terms of hardware and software to accomplish task of any nature in various work environments to handle unforeseen situations. Providing customization according to user requirements.

So that there is a need for an improved humanoid design adaptable, configurable and undergo morphological changes for robot to perform one or more applications. Accordingly, there remains a need for a system for the humanoid robot to perform a list of tasks on various work environmental condition and one or more application in an efficient way.

### SUMMARY

In view of the foregoing, an embodiment herein provides a system for controlling and operating a hyper configurable humanoid robot. The system includes a master control unit. The master control unit includes a memory, and a processor. The memory unit stores a data locally or through cloud, and a set of modules. The memory obtains the data from a perception unit. The processor executes the set of modules. The set of modules includes a work environment accessing module, a communication module, a vision system and LIDAR (Light Detecting and Ranging) module, a feedback analyzing module, an input module, a brain machine interface module, a myoelectric signal detection module, and a finger impression identification module. The work environment accessing module, executed by the processor, is configured to (i) obtain a data from the perception unit to analyze a work conditions, and (ii) perform a list of tasks for the humanoid robot based on one or more sensors. The communication module, executed by the processor, is configured to provide communication between (i) the humanoid robot and a cloud server, and (ii) the cloud server and one or more robots to perform the list of tasks based on one or more sensors. The vision system and LIDAR (Light Detecting and Ranging) module, executed by the processor, is configured to detect an acquisition of image and distance information about a working environmental condition or one or more applications to create a map of the working environmental condition or the one or more applications for navigation. The feedback analyzing module, executed by the processor, is configured to provide a feedback and control information to the humanoid robot. The input module, executed by the processor, is configured to provide an input to the humanoid robot based on (i) an output of the one or more sensors or (ii) the user devices or the user. The brain machine interface module, executed by the processor, is configured to receive an Electroencephalogram (EEG) signal from electrical activity of a human brain of the user to control the humanoid robot. The myoelectric signal detection module, implemented by the processor, is configured to detect an EMG signal from a changing muscle condition of the user to control the humanoid robot. The finger impression identification module, executed by the processor, is configured to identify a finger print of the user for security purposes.

In one embodiment, the system further includes a perception unit that is configured to provide an input/data to the humanoid robot to perform necessary action according to the working environmental condition or the one or more applications based on the one or more sensors, or the user input. The humanoid robot further includes a navigation and control unit, and a monitoring and safety unit. The navigation and control unit is configured to receive a multiple responses from the processor to execute the multiple responses on the humanoid robot for navigation. The humanoid robot acts individually or as a swarm. The monitoring and safety unit is configured to (i) check a right commands given by the user in an operational environment, and (ii) check commands executed during autonomous operation. In another embodiment, the navigation and control unit tracks/maps the working environmental condition or the one or more applications for navigation of the humanoid robot and control an actuator of the humanoid robot. The working environmental condition or the one or more applications are selected from at least one of but not limited to (i) Agriculture application, (ii) Industries application, (iii) Medical application, (iv) Military application, (v) Weather monitoring, (v) Disaster management, and (vi) Domestic application. The humanoid robot includes different types of chassis. The different type of chassis are selected from at least one of but not limited to (i) Biped chassis, (ii) Tracked chassis, (iii) Hexapod chassis, and (iv) Differential drive chassis based on the working environmental condition or the one or more applications.

In another aspect, a processor implemented method for performing and controlling a humanoid robot is provided. The method includes the following steps: (i) obtaining, using a work environment accessing module, a data from a perception unit to analyze a work environmental conditions, (ii) providing, using a communication module, communication between (i) the humanoid robot and a cloud server, and (ii) the cloud server and one or more robots, (iii) detecting, using a vision system and LIDAR module, an acquisition of image and distance information about the working environmental condition or one or more applications to create a map of the working environmental condition for navigation, (iv) providing, using a feedback analyzing module, a feedback and control information to the humanoid robot, and (v) providing, using an input module, an input to the humanoid robot based on the one or more sensors or the user devices or the user to perform a necessary action for the working environmental condition or the one or more applications.

In one embodiment, the method further includes the following steps: (i) receiving, using a brain machine interface module, an Electroencephalogram (EEG) signal from electrical activity of a human brain of the user, (ii) detecting, using a myoelectric signal detection module, an EMG signal from a changing muscle condition of the user, (iii) controlling, the humanoid robot, based on the data, the Electroencephalogram (EEG) signal, and the EMG signal, (iv) identifying, using a finger impression identification module, a finger print of the user for security purpose of the humanoid robot, (v) receiving, using a navigation and control unit, a multiple responses from the processor to execute the multiple responses on the humanoid robot, (vi) tracking/mapping, using the navigation and control unit, the working environmental condition or the one or more applications for navigating the humanoid robot, (vii) checking, using a monitoring and safety unit, a right commands given by the user in an operational environment, and a commands executed during autonomous operation. In another embodiment, the working environmental condition or the one or more applications are selected from at least one of but not limited to (i) Agriculture application, (ii) Industries application, (iii) Medical application, (iv) Military application, (v) Weather monitoring, (v) Disaster management, and (vi) Domestic application. In yet another embodiment, the humanoid robot having a different type of chassis. In yet another embodiment, the different type of chassis are selected from at least one of but not limited to (i) Biped chassis, (ii) Tracked chassis, (iii) Hexapod chassis, and (iv) Differential drive chassis based on the working environmental condition or the one or more applications.

In yet another aspect, a humanoid robot is provided. The humanoid robot includes a perception unit, a master control unit, a monitoring and safety unit, and a navigation and control unit. The perception unit is configured to provide an input/data to the humanoid robot to perform necessary action to a working environmental condition or one or more applications based on one or more sensors, or a user input. The perception unit includes a brain machine interface unit, a myo band and inertial measure unit, a vision and LIDAR system, a biometrics and voice receptor, and a fire and explosive detection unit. The brain machine interface unit is interfaced with a human brain for obtaining an EEG signal from the human brain by providing a biosensor. The EEG signal is transmitted to a microcontroller of the humanoid robot to perform spontaneous and predefined logics. The myo band and inertial measure unit is configured to detect an EMG signal from a muscle of the user to control the humanoid robot. The vision and LIDAR (Light Detecting and Ranging) system is configured to provide a vision and distance information about the working environment conditions or the one or more applications enabling to create a map of the working environment conditions for navigating the humanoid robot. The biometrics and voice receptor that is configured to (i) identify a finger print of the user for security purpose of the humanoid robot, (ii) check the finger print in secured places, and (iii) provide voice commands for the humanoid robot for controlling the movement and/or actions of the humanoid robot. The fire and explosive detection unit is configured to detect a fire accident of the working environmental conditions or the one or more application. The master control unit includes a memory, a processor. The memory unit stores a data locally or through cloud, and a set of modules. The memory unit obtains the data from a perception unit. The processor executes the set of modules. The set of modules includes a work environment accessing module, a communication module, a vision system and LIDAR module, a feedback analyzing module, an input module, a brain machine interface module, a myoelectric signal detection module, and a finger impression identification module. The work environment accessing module, executed by the processor, is configured to (i) obtain a data from the perception unit to analyze a work conditions, and (ii) perform a list of tasks for the humanoid robot based on one or more sensors. The communication module, executed by the processor, is configured to provide communication between (i) the humanoid robot and a cloud server, and (ii) the cloud server and one or more robots to perform the list of tasks based on one or more sensors. The vision system and LIDAR module, executed by the processor, is configured to detect an acquisition of image and distance information about a working environmental condition or one or more applications to create the map of the working environmental condition or the one or more applications for navigation. The feedback analyzing module, executed by the processor, is configured to provide a feedback and control information to the humanoid robot. The input module, executed by the processor, is configured to provide an input to the humanoid robot based on (i) an output of the one or more sensors or (ii) the user devices or the user. The brain machine interface module, executed by the processor, is configured to receive an Electroencephalogram (EEG) signal from electrical activity of a human brain of the user to control the humanoid robot. The myoelectric signal detection module, implemented by the processor, is configured to detect an EMG signal from a changing muscle condition of the user to control the humanoid robot wirelessly. The finger impression identification module, executed by the processor, is configured to identify a finger print of the user for security purpose of the humanoid robot. The monitoring and safety unit is configured to (i) check a right commands given by the user in an operational environment, and (ii) check commands executed during autonomous operation. The navigation and control unit is configured to receive a multiple responses from the processor to execute the multiple responses on the humanoid robot. The humanoid robot acts individually or as a swarm.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a humanoid robot depicting various units and a data obtained from various sensor inputs from a perception unit is used to assess work environment condition for one or more applications for performing a list of tasks with network and a user according to an embodiment herein;

FIG. 2 illustrates an exploded view of a perception unit of the humanoid robot of FIG. 1 in accordance with an embodiment;

FIG. 3 illustrates an exploded view of a master control unit 106 which coordinates the process and control of all the units of the humanoid robot 102 of FIG. 1 in accordance with an embodiment;

FIG. 4 illustrates an exploded view of one or more sensors in sensors equipped based on application of FIG. 1 according to an embodiment herein;

FIG. 5 illustrates an example of how the humanoid robot can communicate and interact with the user for a haptic control unit of the humanoid robot of FIG. 1 according to an embodiment herein;

FIG. 6 illustrates an example of how the humanoid robot communicate between one or more the humanoid robots and interact with an working environmental condition or one or more application using one or more sensors of FIG. 1 according to an embodiment herein;

FIG. 7 illustrates an example of how one or more humanoid robots communicate sensor data between one or more robots for swarm behavior and interact with a working environmental condition or one or more application of FIG. 1 according to an embodiment herein;

FIG. 8 illustrates an exploded view of a navigation and control unit 110 of the humanoid robot 102 of FIG. 1 in accordance with an embodiment;

FIGS. 9A and 9B illustrates a different type of chassis attachable to the humanoid robot 102 of FIG. 1 in accordance with an embodiment;

FIG. 10 is a flow diagram illustrating a method for performing and controlling a humanoid robot of FIG. 1 according to an embodiment herein;

FIG. 11 illustrates an exploded view of a personal communication device according to the embodiments herein; and

FIG. 12 a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

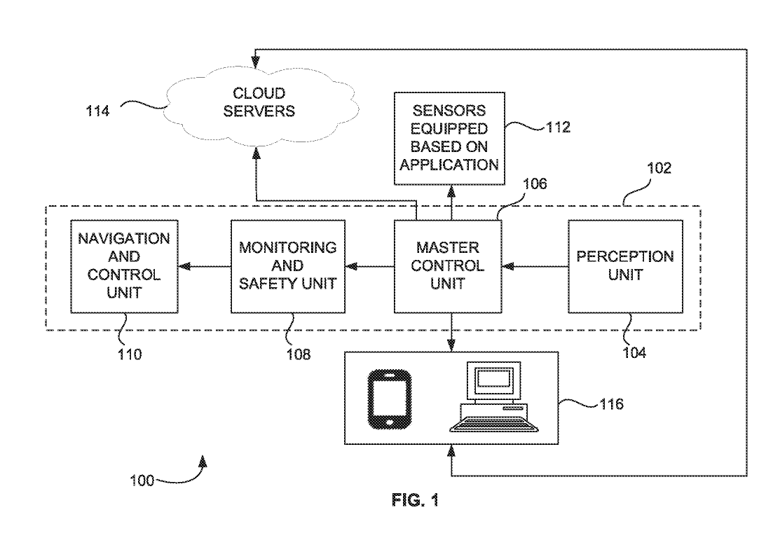

As mentioned, there remains a need of a system for a humanoid robot that can perform a list of tasks on various working environmental condition or one or more application in an efficient way. The embodiments herein achieve this by providing the humanoid robot that automatically interacts with the working environmental condition or one or more application for performing the list of tasks using a cloud server and a user which acts autonomously or by manual operation. Referring now to the drawings, and more particularly to FIGS. 1 through 12, where similar reference characters denote corresponding features consistently throughout the figures, there are shown preferred embodiments.

FIG. 1 illustrates a system view of a humanoid robot depicting various units and a data obtained from various sensor inputs from a perception unit is used to assess work environment condition for one or more applications for performing a list of tasks with network and a user according to an embodiment herein. The humanoid robot 102 obtains a sensor data from the perception unit 104 to perform the list of tasks (such as providing telepresence, telemonitoring, fire detection and control, irrigation and fertilizer application in agricultural fields, land mine detection, rescue missions and industrial monitoring etc.,) through customization. The humanoid robot 102 obtains the list of tasks from working environmental condition or one or more applications for performing the list of tasks with processor in a master control unit 106 and cloud server 114. In one embodiment, the humanoid robot 102 includes sensors equipped based on application 112, and a user device 116. The humanoid robot 102 further includes a perception unit 104, a master control unit 106, a monitoring and safety unit 108, and a navigation and control unit 110. The humanoid robot 102 obtains the list of tasks from the working environmental condition or one or more applications to perform a necessary action based on the list of tasks. In one embodiment, the sensors equipped based on application 112 may communicate with the cloud server 114 to operate the humanoid robot 102 for performing the necessary action to the working environmental condition or one or more applications and send alert messages to a user device 116 through the cloud server 114. The user devices 116 may include a personal computer (PC), a mobile communication device, a smart phone, a tablet PC, a laptop, a desktop, an ultra-book, any other network device capable of connecting to the cloud server 114 for operational purposes. The working environmental condition or one or more applications may include, but is not limited to an aid rescue missions, a military tasks, a monitoring safety of factory and indoors, a disaster management, an agriculture application, a automation of educational institutions, a helping the disabled, a hospital automation, and in household applications and the like. In an embodiment, the cloud server 114 includes, but is not limited to an internet, intranet, a wide area network, a wired cable network, a broadcasting network, a wired communication network, a wireless communication network, a fixed wireless network, a mobile wireless network, and the like. The perception unit 104 is configured to provide an input/a data to the humanoid robot 102 to performing the necessary action to the working environmental condition or one or more applications based on one or more sensors, a user, and the user devices 116. In one embodiment, the input/data is a control signal to activate the humanoid robot 102 to perform the necessary action to the working environmental condition or one or more applications. The master control unit 106 is configured to coordinate other units in the system to execute the list of tasks based on the input from perception unit 104. In one embodiment, the master control unit 106 is configured to operate the humanoid robot 102 to performing the necessary action to the working environmental condition or one or more applications, based on the input received from perception unit 104. The monitoring and safety unit 108 is configured to receive a feedback from one or more sensors and a feedback from the navigation and control unit 110 to check for the right commands during autonomous and manual mode for operating the humanoid robot 102 based on a feedback loop. The monitoring and safety unit 108 is configured to check a right command given by the user in the working environmental condition. The navigation and control unit 110 is configured to track/map the working environmental condition or one or more applications for navigating the humanoid robot 102 and to control an actuators and an end effectors for the working environmental condition or one or more applications through cloud server 114 and local processing in the master control unit 106. The navigation and control unit 110 is configured to receive multiple responses from the processor to execute the multiple responses (list of tasks) on the humanoid robot 102. In one embodiment, the humanoid robot 102 acts individually or as a swarm. The units specified in the humanoid robot 102 may implemented as discrete units or be implemented on a single board (e.g. a printed circuit board).

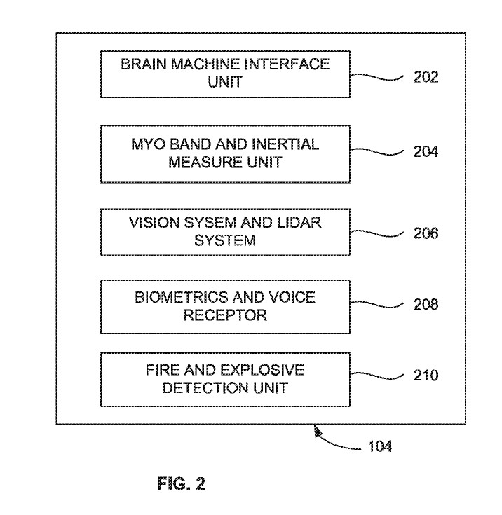

FIG. 2 illustrates an exploded view of a perception unit 104 of the humanoid robot 102 of FIG. 1 in accordance with an embodiment. The perception unit 104 includes a brain machine interface unit 202, a myo band and inertial measure unit 204, a vision and LIDAR system 206, a biometrics and voice receptor 208, and a fire and explosive detection unit 210. The brain machine interface unit 202 is interfaced with a human brain for obtaining an EEG signal from the human brain by providing a biosensor. In one embodiment, the EEG signal from the human brain is transmitted to a microcontroller of the humanoid robot 102 to perform spontaneous and predefined logics. In one embodiment, the output of the microcontroller controls the actions of humanoid robot 102. The myo band and inertial measure unit 204 is configured to detect an EMG signal from a muscle of a user to control the humanoid robot 102. In one embodiment, the user is able to control the humanoid robot 102 with the EMG signal for changing muscle condition. The vision and LIDAR system 206 is configured to provide a vision (e.g., a image of the environmental condition) and distance information about the working environment condition or one or more applications enabling to create map of the work environment condition for navigation. The biometrics and voice receptor 208 is configured to (i) identify a finger print of the user for security purpose of the humanoid robot 102, (ii) to check the finger print in secured places, and (iii) provide voice commands for the humanoid robot 102 for controlling the movement and/or actions of the humanoid robot 102. The fire and explosive detection unit 210 is configured to detect a fire accident of the work environmental condition or one or more application.

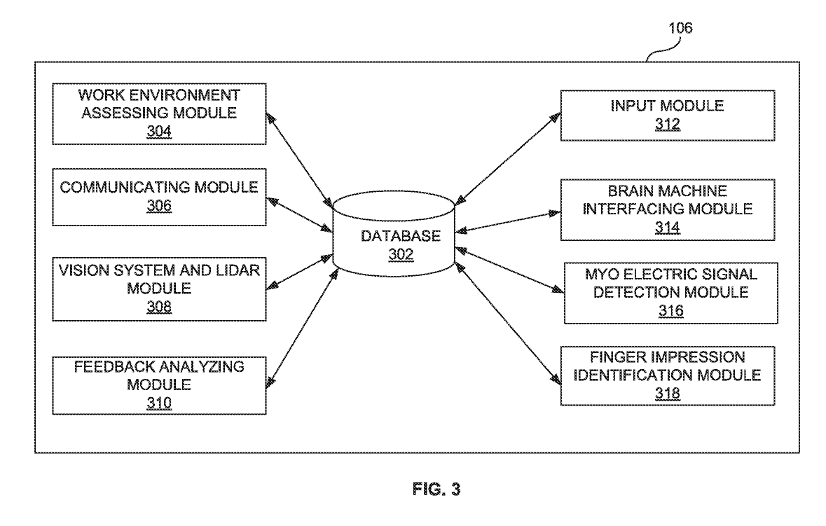

FIG. 3 illustrates an exploded view of a master control unit 106 which coordinates the process and control of all the units of the humanoid robot 102 of FIG. 1 in accordance with an embodiment. The master unit 106 includes a database 302, a work environment accessing module 304, a communication module 306, a vision system and LIDAR module 308, a feedback analyzing module 310, an input module 312, a brain machine interfacing module 314, a myoelectric signal detection module 316, and a finger impression identification module 318 for further processing and storage. Processing may also be done virtually on cloud server 114 for the working environmental condition or one or more applications. The master control unit 106 automatically generates control system specific for the task based on input provided by the work environment accessing module 304. The master control unit 106 utilizes natural language processing, AI, Genetic algorithms and ANN algorithms and the like for processing, decision making and predicting future conditions based on previously acquired data. The database 302 that may obtain a data from a set of modules which may denote both hardware and software module. In one embodiment, the database 302 stores the data received from the set of modules. The work environment accessing module 304 is configured to obtain a data from the perception unit 104 to analyze a work conditions and perform a list of tasks (such as providing telepresence, telemonitoring, fire detection and control, irrigation and fertilizer application in agricultural fields, land mine detection, rescue missions and industrial monitoring etc.,) for the humanoid robot 102 based on one or more sensors. In one embodiment, the data is a control signal to activate the humanoid robot 102 to perform the necessary action to the working environmental condition or one or more applications. The communication module 306 is configured to provide communication between (i) the humanoid robot 102 and the cloud server 114, (ii) the cloud server 114 and one or more robots, (iii) the humanoid robot 102 and the user, (iv) the humanoid robot 102 and the user devices 116, through the cloud server 114, (v) the humanoid robot 102 and the one or more robots, and (v) between communication beacons. The vision system and LIDAR module 308 is configured to detect an acquisition of image and distance information about the working environmental condition or one or more applications enabling to create a map of the working environmental condition for navigation. The feedback analyzing module 310 is configured to provide a feedback and control information to the humanoid robot 102. Based on the feedback the humanoid robot 102 performs the movement and necessary action. The control information may be a signal to control the actions of humanoid robot 102. The input module 312 is configured to provide an input to the humanoid robot 102 based on an output of one or more sensors or the user devices 116 or the user to perform a necessary action for the working environmental condition or the one or more applications. In one embodiment, the input may include and not limited to a voice command, a numerical values and the like. The brain machine interfacing module 314 is configured to receive an electroencephalogram (EEG) signal from an electrical activity of the human brain by interfacing the humanoid robot 102. In an embodiment, the brain machine interface module 314 is configured to detect an electroencephalogram (EEG) signal from an electrical activity of the human brain. In one embodiment, the humanoid robot 102 is controlled by the user thoughts by providing the brain machine interface module 314. The myoelectric signal detection module 316 is configured to detect (by invasive or noninvasive method) an EMG signal from changing muscle condition of the user. In one embodiment, the user is able to control the humanoid robot 102 with the EMG signal about changing muscle condition by employing the myoelectric signal detection module 316. The finger impression identification module 318 is configured to identify a finger print of the user for security purpose of the humanoid robot 102.

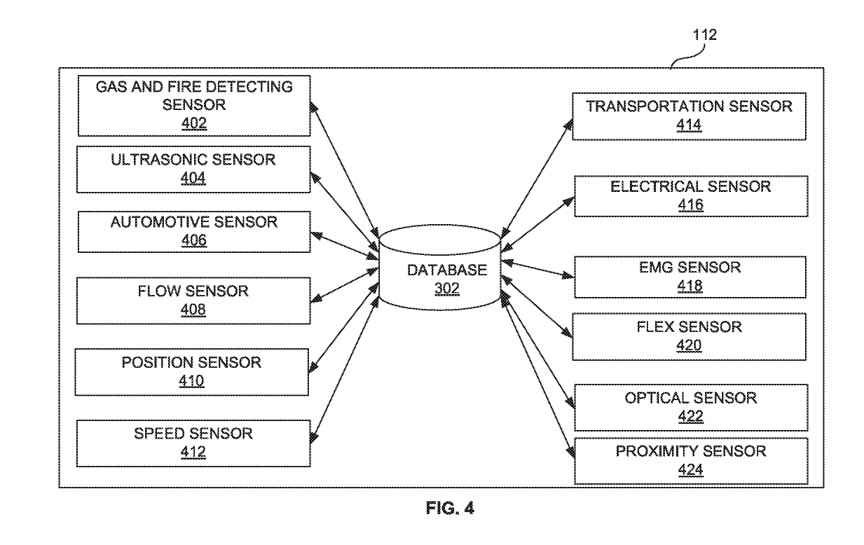

FIG. 4 illustrates an exploded view of one or more sensors in sensors equipped based on application of FIG. 1 according to an embodiment herein. In one embodiment, one or more sensors includes, but is not limited to a gas and fire detection sensor 402, an ultrasonic sensor 404, a automotive sensor 406, a flow sensor 408, a position sensor 410, a speed sensor 412, a transportation sensor 414, a electrical sensor 416, a EMG sensor 418, a flex sensor 420, an optical sensor 422, and a proximity sensor 424. In one embodiment, one or more sensors is coupled with the humanoid robot 102 or located in the working environmental condition or to suite one or more applications.

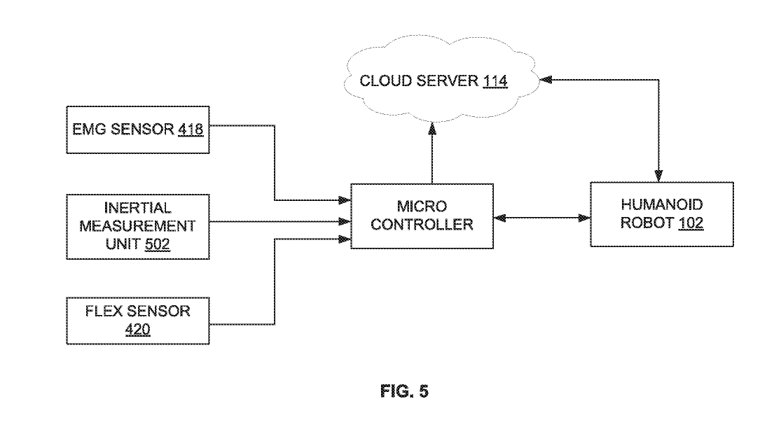

FIG. 5 illustrates an example of how the humanoid robot 102 can communicate and interact with the user for a haptic control unit of the humanoid robot 102 of FIG. 1 according to an embodiment herein. The EMG sensor 418, the flex sensor 420, and an Inertial Measurement Unit (IMU) 502 are adapted to couple the user with humanoid robot 102 to obtain a medical data (e.g. a pulse, an ECG signal, and the like) from the user and the IMU 502 for detecting gestures and other vital parameters. In one embodiment, the haptic control unit coupled to user may communicate to the humanoid robot 102 through cloud server 114 for long distances or may communicate with Bluetooth, Xbee and the like for short range communication. In one embodiment, for medical applications the perception unit 104 equipped with medical sensors to obtain the medical data from the user and communicate the medical data to the humanoid robot 102 through the cloud server 114. In another embodiment, the humanoid robot 102 is adapted to communicate between a doctor and a patient by providing a telepresence through the cloud server 114. Based on the input received from the perception unit 104, the humanoid robot 102 performs the necessary action for the medical application.

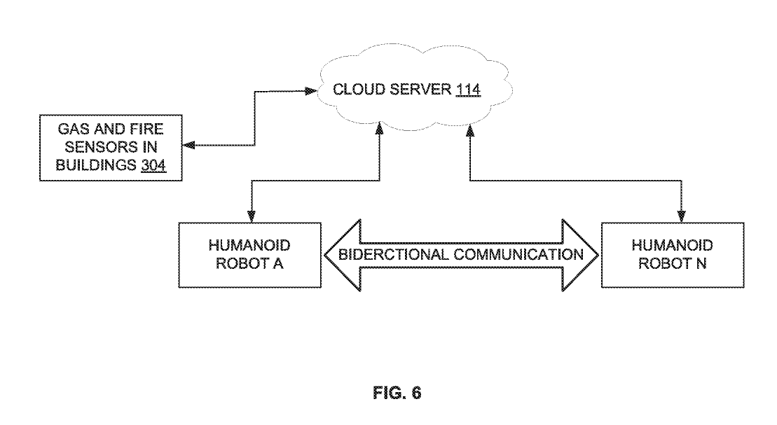

FIG. 6 illustrates an example of how the humanoid robot 102 communicate between one or more humanoid robots and interact with an working environmental condition or one or more application using one or more sensors of FIG. 1 according to an embodiment herein. The gas and fire detection sensor 402 is either present in the working environmental condition or equipped in the perception unit 104. In one embodiment, the gas and fire detection sensor 402 is adapted to obtain a hazard data from the working environmental condition and communicate the hazard data to the humanoid robot 102. The hazard data may include but not limited to a gas leakage, a fire accident, a product breakage, a product countdown, and the like. The humanoid robot 102 communicates the hazard data to the user and the user devices 116 through the cloud server 114 for prevent/predict a hazardous condition. In another embodiment, the humanoid robot 102 communicates the hazard data to one or more humanoid robot through the cloud server 114 for swarm behavior to cooperatively prevent/predict the hazard data. In yet another embodiment, the working environmental condition or one or more application may includes, but is not limited to a industrial application, a factory application, a building monitoring application, agricultural application, and the like.

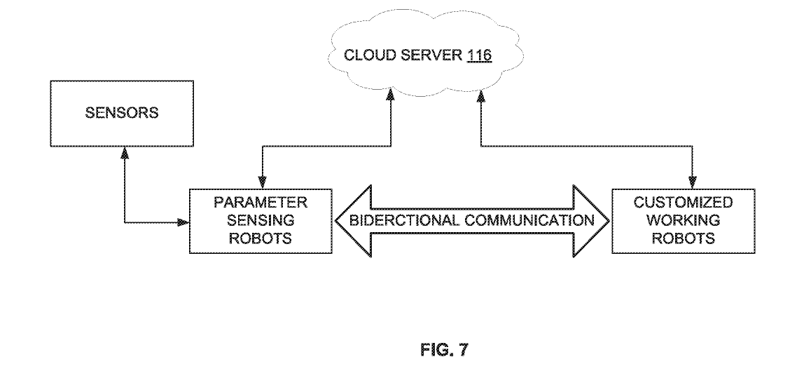

FIG. 7 illustrates an example of how one or more humanoid robots communicate sensor data between one or more robots for swarm behavior and interact with a working environmental condition or one or more application of FIG. 1 according to an embodiment herein. In one embodiment, for an agriculture application one or more sensors are either present in one or more agriculture applications or equipped in the perception unit 104. The one or more sensors are adapted to obtain an agriculture data from the one or more agriculture applications and communicate the agriculture data between one or more humanoid robots which is configured as parameter sensing robots and working robots to perform the necessary action for the agricultural application. The agriculture data may include but not limited to a fertilizer requirement, a water requirement condition, and the like. The one or more humanoid robots communicate the agriculture data to the user and the user devices 116 through the cloud server 114 for prevent/predict the agriculture data.

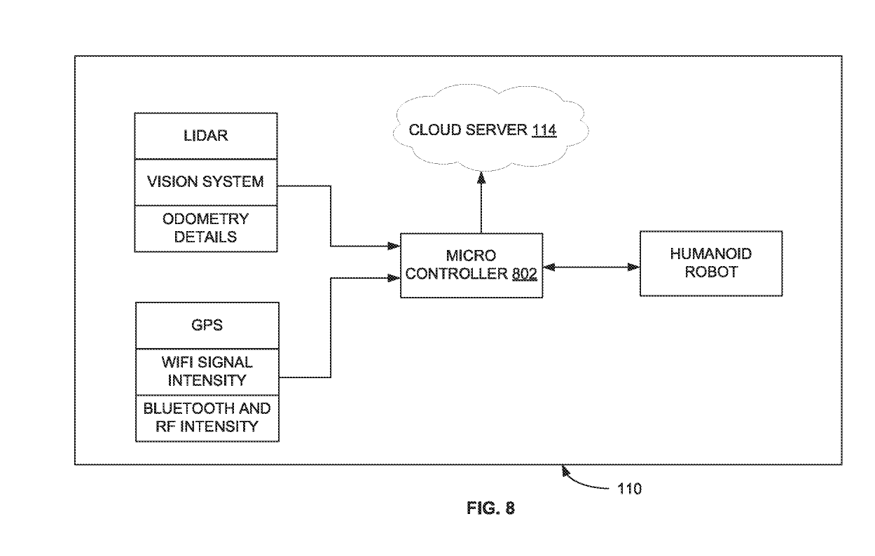

FIG. 8 illustrates an exploded view of a navigation and control unit 110 of the humanoid robot 102 of FIG. 1 in accordance with an embodiment. The navigation and control unit 110 includes a microcontroller 802, vision and LIDAR system 206 in the perception unit 104 is coupled with the navigation and control unit 110 through the master control unit 106 and also it utilizes odometry details from encoders, a GPS unit, a wifi signal intensity unit, or a Bluetooth or RF intensity unit based on task performed. The microcontroller 802 is configured to receive a multiple responses from the perception unit 104 to control the humanoid robot 102 by performing spontaneous and predefined logics. The vision and LIDAR unit, the GPS unit, the Wi-Fi signal intensity unit, and the Bluetooth and RF intensity unit are collectively used for navigation of the humanoid robot 102 for performing the necessary action. The navigation and control unit 110 may utilize several navigation algorithms like SLAM, Bug, and Genetic and access maps/data from master control unit 106.

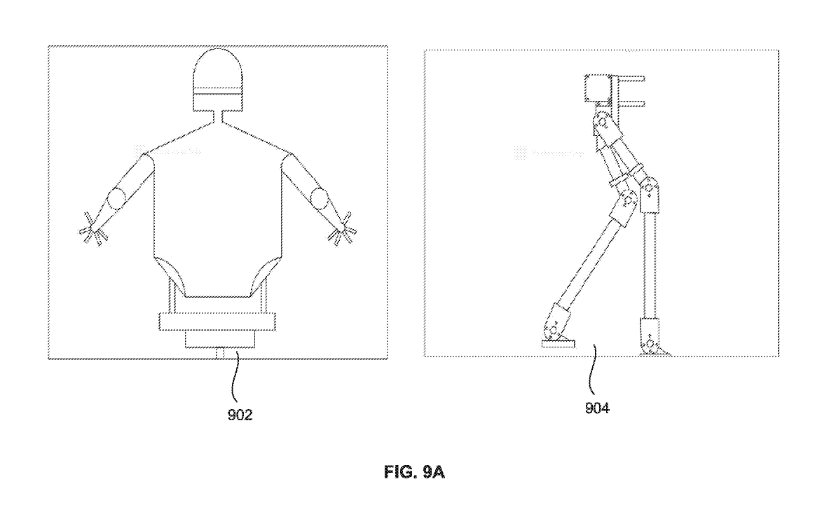

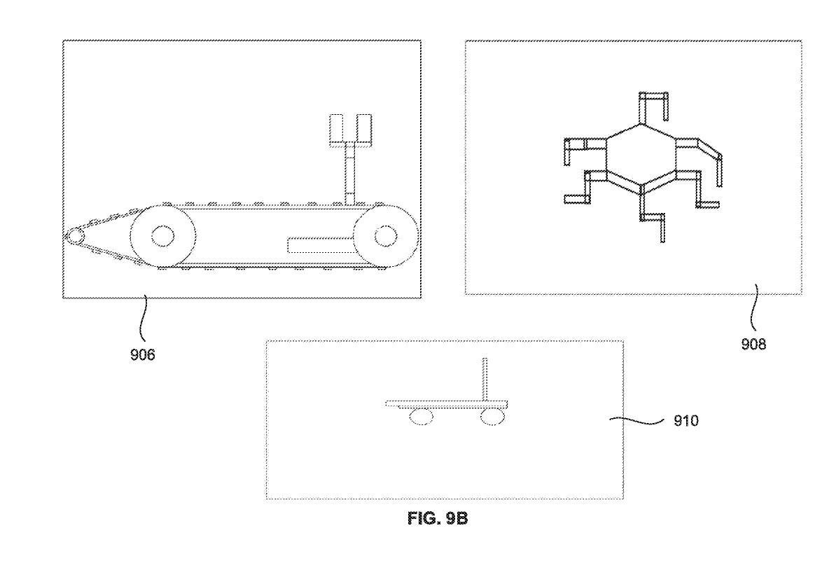

FIGS. 9A and 9B illustrates a different type of chassis attachable to the humanoid robot 102 of FIG. 1 in accordance with an embodiment. The different type of chassis may includes, but is not limited to, a biped hardware type chassis 904, a tracked type chassis 906, a hexapod type chassis 908, a differential drive type chassis 910, and the like. In one embodiment, the different type of chassis is fixed with the humanoid robot 102 based on the working environmental condition or one or more application.

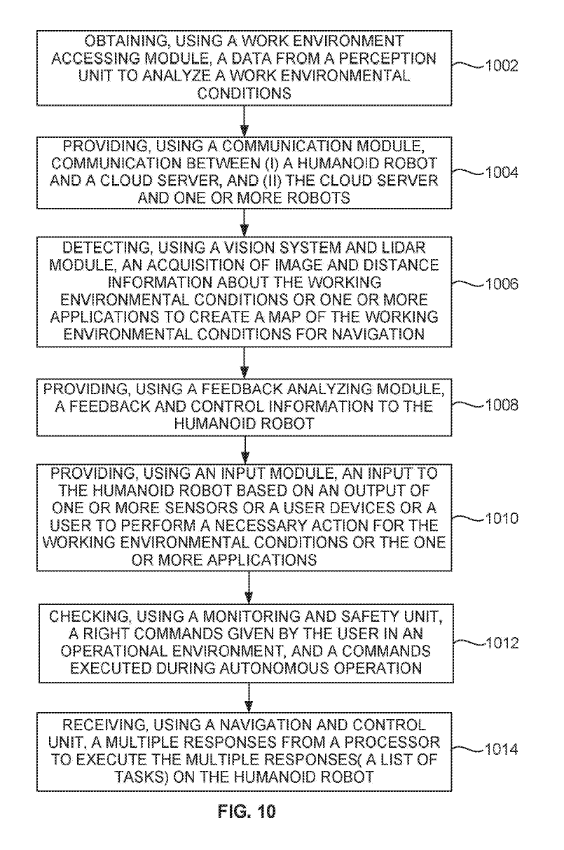

FIG. 10 is a flow diagram illustrating a method for performing and controlling a humanoid robot 102 of FIG. 1 according to an embodiment herein. At step 1002, the work environment accessing module 304 is configured to obtain a data from the perception unit 104 to analyze a work conditions and perform a list of tasks (such as providing telepresence, telemonitoring, fire detection and control, irrigation and fertilizer application in agricultural fields, land mine detection, rescue missions and industrial monitoring etc.,) for the humanoid robot 102 based on one or more sensors. In one embodiment, the data is a control signal to activate the humanoid robot 102 to perform the necessary action to the working environmental condition or one or more applications. At step 1004, the communication module 306 is configured to provide communication between (i) the humanoid robot 102 and the cloud server 114, (ii) the cloud server 114 and one or more robots, (iii) the humanoid robot 102 and the user, and (iv) the humanoid robot 102 and the user devices 116, through the cloud server 114. At step 1006, the vision system and LIDAR module 308 is configured to detect an acquisition of image and distance information about the working environmental condition or one or more applications enabling to create a map of the working environmental condition for navigation. At step 1008, the feedback analyzing module 310 is configured to provide a feedback and control information to the humanoid robot 102. In one embodiment, based on the feedback the humanoid robot 102 performs the movement and necessary action. At step 1010, the input module 312 is configured to provide an input to the humanoid robot 102 based on one or more sensors or the user devices 116 or the user to perform a necessary action for the working environmental condition or the one or more applications. At step 1012, the monitoring and safety unit 108 is configured to check a right command given by the user in the working environmental condition. At step 1014, the navigation and control unit 110 is configured to receive a multiple responses from the processor to execute the multiple responses (the list of tasks) on the humanoid robot 102.

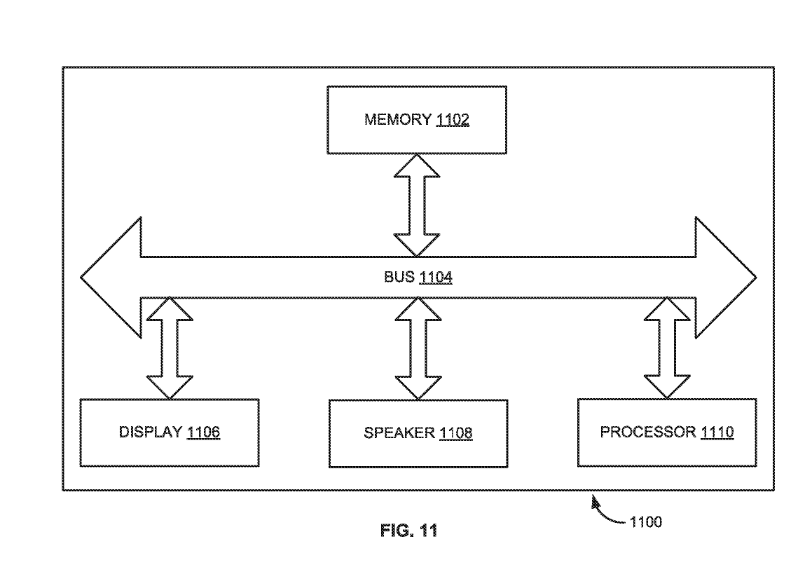

FIG. 11 illustrates an exploded view of the personal communication device having an a memory 1102 having a set of computer instructions, a bus 1104, a display 1106, a speaker 1108, and a processor 1110 capable of processing a set of instructions to perform any one or more of the methodologies herein, according to an embodiment herein. In one embodiment, the receiver may be the personal communication device. The processor 1110 may also enable digital content to be consumed in the form of video for output via one or more displays 1106 or audio for output via speaker and/or earphones 1108. The processor 1110 may also carry out the methods described herein and in accordance with the embodiments herein.

Digital content may also be stored in the memory 1102 for future processing or consumption. The memory 1102 may also store program specific information and/or service information (PSI/SI), including information about digital content (e.g., the detected information bits) available in the future or stored from the past. A user of the personal communication device may view this stored information on display 1106 and select an item of for viewing, listening, or other uses via input, which may take the form of keypad, scroll, or other input device(s) or combinations thereof. When digital content is selected, the processor 1110 may pass information. The content and PSI/SI may be passed among functions within the personal communication device using the bus 1104.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. Software may be provided for drag and drop programming and specific Operating System may be provided it may also include a cloud based service for virtual software processing/teleprocessing. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

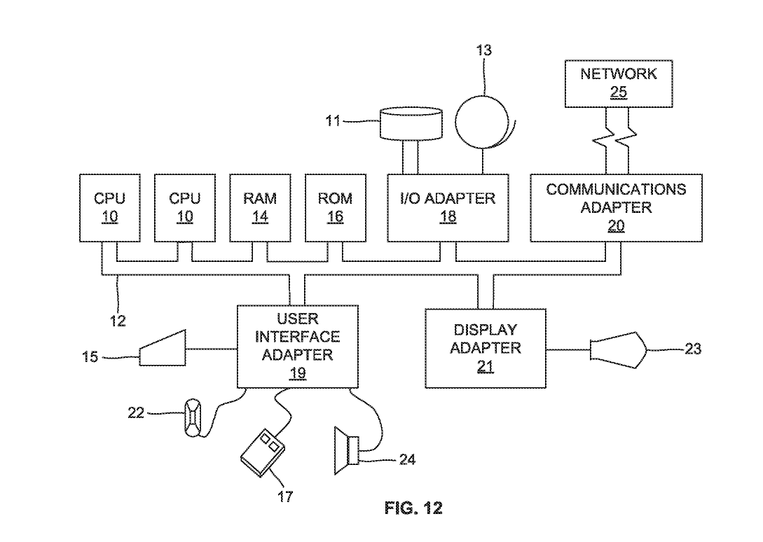

A representative hardware environment for practicing the embodiments herein is depicted in FIG. 12. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, other program storage devices that are readable by the system. The system can read the inventive instructions on the program storage devices and follow these instructions to execute the methodology of the embodiments herein.

The system further includes a user interface adapter 19 that may connects to a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The humanoid robot 102 design is a common platform that can be automated and customized based on the specified task providing greater flexibility to support military applications such as land mine detection and mapping of safe path to soldiers and vehicles, to aid agriculture in deciding and applying right amount of fertilizers and irrigation solutions, in rescue missions to locate humans and industrial safety monitoring in factories and to help the disabled and elderly. The Architecture for operation and control of humanoid robot 102 can be used for but not limited to autonomous cars, exoskeleton, prosthetics, drones, autonomous material handling systems, Co-working robots, general autonomous machinery, heavy vehicles and machines for logistics.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. A system for controlling and operating a hyper configurable humanoid robot, said system comprising:
a master control unit comprises:
a memory that stores a data locally or through cloud, and a set of modules, wherein said memory obtains said data from a perception unit; and
a processor that executes said set of modules, wherein said set of modules comprises:
a work environment accessing module, executed by said processor, configured to (i) obtain a data from said perception unit to analyze a work conditions, and (ii) perform a list of tasks for said humanoid robot based on a plurality of sensors;
a communication module, executed by said processor, configured to provides communication between (i) said humanoid robot and a cloud server, and (ii) said cloud server and a plurality of robots to perform said list of tasks based on said plurality of sensors;
a vision system and LIDAR (Light Detecting and Ranging) module, executed by said processor, configured to detect an acquisition of image and distance information about a working environmental condition or a plurality of applications to create a map of said working environmental condition or said plurality of applications for navigation;
a feedback analyzing module, executed by said processor, configured to provide a feedback and control information to said humanoid robot;
an input module, executed by said processor, configured to provide an input to said humanoid robot based on (i) an output of said plurality of sensors or (ii) said user devices or said user.
a brain machine interface module, executed by said processor, configured to receive an Electroencephalogram (EEG) signal from electrical activity of a human brain of said user to control said humanoid robot;
a myoelectric signal detection module, implemented by said processor, configured to detect an EMG signal from a changing muscle condition of said user to control said humanoid robot; and
a finger impression identification module, executed by said processor, configured to identify a finger print of said user for security purpose of said humanoid robot.

2. The system as claimed in claim 1, wherein said system further comprises said perception unit that is configured to provide an input/data to said humanoid robot to perform necessary action to said working environmental condition or said plurality of applications based on said plurality of sensors, or said user input.

3. The system as claimed in claim 1, wherein said humanoid robot further comprises:
a navigation and control unit is configured to receive a multiple responses from said processor to execute said multiple responses on said humanoid robot, wherein said humanoid robot acts individually or as a swarm; and
a monitoring and safety unit is configured to (i) check a right commands given by said user in an operational environment, and (ii) check commands executed during autonomous operation;
wherein said navigation and control unit tracks/maps said working environmental condition or said plurality of applications for navigating said humanoid robot 102 and control an actuator of said humanoid robot.

4. The system as claimed in claim 1, wherein said working environmental condition or said plurality of applications are selected from at least one of but not limited to (i) Agriculture application, (ii) Industries application, (iii) Medical application, (iv) Military application, (v) Weather monitoring, (v) Disaster management, and (vi) Domestic application.

5. The system as claimed in claim 1, wherein said humanoid robot comprises a different type of chassis, wherein said different type of chassis are selected from at least one of but not limited to (i) Biped chassis, (ii) Tracked chassis, (iii) Hexapod chassis, and (iv) Differential drive chassis based on said working environmental condition or said plurality of applications.

6. A processor implemented method for performing and controlling a humanoid robot, said method comprising:
obtaining, using a work environment accessing module, a data from a perception unit to analyze a working environmental conditions;
providing, using a communication module, communication between (i) said humanoid robot and a cloud server, and (ii) said cloud server and a plurality of robots;
detecting, using a vision system and LIDAR (Light Detecting and Ranging) module, an acquisition of image and distance information about said working environmental condition or a plurality of applications to create a map of said working environmental condition for navigation;
providing, using a feedback analyzing module, a feedback and control information to said humanoid robot; and
providing, using an input module, an input to said humanoid robot based on said plurality of sensors or said user devices or said user to perform a necessary action for said working environmental condition or said plurality of applications.

7. The method as claimed in claim 6, wherein said method further comprises:
receiving, using a brain machine interface module, an Electroencephalogram (EEG) signal from electrical activity of a human brain of said user;
detecting, using a myoelectric signal detection module, an EMG signal from a changing muscle condition of said user;
controlling, said humanoid robot, based on said data, said Electroencephalogram (EEG) signal, and said EMG signal;
identifying, using a finger impression identification module, a finger print of said user for security purpose of said humanoid robot;
receiving, using a navigation and control unit, a multiple responses from said processor to execute said multiple responses on said humanoid robot;
tracking/mapping, using said navigation and control unit, said working environmental condition or said plurality of applications for navigating said humanoid robot; and
checking, using a monitoring and safety unit, a right commands given by said user in an operational environment, and a commands executed during autonomous operation;

8. The method as claimed in claim 6, wherein said working environmental condition or said plurality of applications are selected from at least one of but not limited to (i) Agriculture application, (ii) Industries application, (iii) Medical application, (iv) Military application, (v) Weather monitoring and (v) Disaster management (vi) Domestic application.

9. The method as claimed in claim 6, wherein said humanoid robot comprises a different type of chassis, wherein said different type of chassis are selected from at least one of but not limited to (i) Biped chassis, (ii) Tracked chassis, (iii) Hexapod chassis, and (iv) Differential drive chassis based on said working environmental condition or said plurality of applications.

10. A humanoid robot comprising:
(a) a perception unit that is configured to provide an input/data to said humanoid robot to perform necessary action to a working environmental condition or a plurality of applications based on a plurality of sensors, or a user input, wherein said perception unit comprises:
a brain machine interface unit that is interfaced with a human brain for obtaining an EEG signal from said human brain by providing a biosensor, wherein said EEG signal is transmitted to a microcontroller of said humanoid robot to perform spontaneous and predefined logics;
a myo band and inertial measure unit that is configured to detect an EMG signal from a muscle of said user to control said humanoid robot;
a vision and LIDAR system that is configured to provide a vision and distance information about said working environment conditions or said plurality of applications enabling to create a map of said working environment conditions for navigating said humanoid robot;
a biometrics and voice receptor that is configured to (i) identify a finger print of said user for security purpose of said humanoid robot, (ii) check the finger print in secured places, and (ii) provide voice commands for said humanoid robot for controlling the movement and/or actions of said humanoid robot; and
a fire and explosive detection unit that is configured to detect a fire accident of said working environmental conditions or said plurality of application; (b) a master control unit that comprises:
a memory that stores a data locally or through cloud, and a set of modules, wherein said memory obtains said data from a perception unit; and
a processor that executes said set of modules, wherein said set of modules comprises:
a work environment accessing module, executed by said processor, configured to (i) obtain a data from said perception unit to analyze a work conditions and (ii) perform a list of tasks for said humanoid robot based on said plurality of sensors;
a communication module, executed by said processor, configured to provides communication between (i) said humanoid robot and a cloud server, and (ii) said cloud server and a plurality of robots to perform said list of tasks based on said plurality of sensors;
a vision system and LIDAR module, executed by said processor, configured to detect an acquisition of image and distance information about a working environmental condition or said plurality of applications to create said map of said working environmental condition or said plurality of applications for navigation;
a feedback analyzing module, executed by said processor, configured to provide a feedback and control information to said humanoid robot;
an input module, executed by said processor, configured to provide an input to said humanoid robot based on said plurality of sensors output or a user devices or said user;
a brain machine interface module, executed by said processor, configured to receive an Electroencephalogram (EEG) signal from electrical activity of said human brain to control said humanoid robot;
a myoelectric signal detection module, implemented by said processor, configured to detect an EMG signal from a changing muscle condition of said user to control said humanoid robot; and
a finger impression identification module, executed by said processor, configured to identify a finger print of said user for security purpose of said humanoid robot;
(c) a monitoring and safety unit that is configured to (i) check a right commands given by said user in said working environmental, and (ii) check commands executed during autonomous operation; and
(d) a navigation and control unit that is configured to receive a multiple responses from said processor to execute that said multiple responses on said humanoid robot, wherein said humanoid robot acts individually or as a swarm.
